(19) United States
(12) Patent Application Publication
(10) Pub. No.: US 2019/0170196 A1
(43) Pub. Date: Jun. 6, 2019

(54) DRIVE SHAFT ENGAGEMENT AND METHODS

(71) Applicant: Actuant Corporation, Menomonee Falls, WI (US)

(72) Inventors: Daryl Jaeger, West Bend, WI (US); Benjamin William Keeton, Milwaukee, WI (US)

(21) Appl. No.: 16/302,285

(22) PCT Filed: May 18, 2017
(86) PCT No.: PCT/US2017/033424

§ 371 Date: Nov. 16, 2018

Related U.S. Application Data
(60) Provisional application No. 62/338,321, filed on May 18, 2016.
(60) Provisional application No. 62/338,328, filed on May 18, 2016.
(60) Provisional application No. 62/341,925, filed on May 26, 2016.

(51) Int. Cl. F16D 3/38; F16D 1/116; F16D 3/40

(52) U.S. Cl. CPC F16D 3/387; F16D 2001/103; F16D 3/40; F16D 1/116

(57) ABSTRACT

An engagement assembly between a drive shaft and a driven shaft for a vehicle, a power take-off coupling, a method of engaging a drive shaft and a driven shaft, an articulated drive shaft assembly, a universal joint and a coupler assembly. The engagement assembly may include a drive shaft including first splines having respective tapered ends; and a driven shaft including second splines having respective tapered ends tapering. The tapered ends may facilitate engagement and alignment of the first splines and the second splines. A universal joint may include a locking assembly to selectively hold the driven shaft and the shaft in an orientation during connection. A coupler assembly may be adjustable between a locked condition, in which the drive shaft is locked to the driven shaft, and an unlocked condition, and may include first indicia indicative of a locked condition, and second indicia indicative of an unlocked condition.

### RELATED APPLICATIONS

The present application claims priority to U.S. Provisional Patent Application No. 62/338,328, filed May 18, 2016; to U.S. Provisional Patent Application No. 62/338,321, filed May 18, 2016; and to U.S. Provisional Patent Application No. 62/341,925, filed May 26, 2016, the entire contents of all of which are hereby incorporated by reference.

### FIELD

The present invention generally relates to engagement of drive shafts and, more particularly, for such drive shafts including, for example, a splined engagement, an articulated arrangement and/or an indicator.

### SUMMARY

Many tractors, trucks, or other off-highway vehicles are provided with power take-off shafts having terminal splined male coupling elements. Many implements with which such vehicles are used have flexibly-jointed and extensible driven shafts with female coupling elements (i.e., power input connection) adapted to receive the power take-off shaft of the vehicle. Inasmuch as neither the power take-off shaft nor the driven shaft can ordinarily be rotated by hand, it becomes a very difficult matter to register the splines of the respective coupling elements when they are not properly aligned.

Flexibly-jointed driven shafts for transmitting motion to an implement from the power take-off shaft of a vehicle weigh as much as 70 to 80 pounds. This can make connecting two devices together quite complicated if the splines are not properly aligned to allow for registration automatically.

In addition, some shaft engagement locations are in a confined space, hidden from view (such as due to guards or other obstructions), and/or ergonomically challenging, making alignment of the shafts difficult. As such, the operator may not be able to see the splines while trying to connect the assembly.

Attempts have been made at providing a taper to an end of the one of the splines, such as is shown in U.S. Pat. No. 3,249,377, the entire contents of which is hereby incorporated by reference. Although this arrangement may improve the rate of registration, several attempts to register the connection properly in certain circumstances may be required. For example, as shown in FIG. 1 from U.S. Pat. No. 3,249,377, the splines 10 of the power take-off shaft 6 and the splines 14 of the female coupling element each terminate at a blunt end surface 22. When these blunt end surfaces 22 happen to align (or partially align) during attempts to interconnect the coupling, the splines 10, 14 will not register.

Making the connection between the drive shaft and the driven shaft more complex is that many driven shafts have ends that are articulated. For example, many have a universal joint adjacent each end of the driven shaft. During connection, it is common to grasp the driven shaft primarily by the shaft, due to the weight, which will result in the articulated end pivoting into a non-aligned orientation. To further effectuate the connection, one must hold the driven shaft while also attempting to articulate the joint into alignment and while attempting to engage splines with tight tolerances.

Due to the weight of the shaft, tight tolerances of the splines, the articulated ends and/or other complicating factors, alignment and engagement of the splined connection between the drive shaft and the driven shaft can be quite difficult, with many attempts required before registry is made.

A need may exist for an easier way to register the splines of male and female members of a power take-off coupling without the need to make multiple attempts.

A need may exist to limit or prevent the articulation during engagement of the driven shaft with the drive shaft.

U.S. Pat. Nos. 4,900,181; 4,960,344; 5,632,568; and 6,666,614, the entire contents of each of which are hereby incorporated by reference, disclose couplers for removably locking a hub axially on a shaft. The hub can have an end which is the yoke of a universal joint for attachment to a power drive assembly rotating the shaft (e.g., the power input shaft of an agricultural implement to the power takeoff shaft of a tractor). As mentioned above, the hub is internally splined to match the external splines on the power takeoff shaft to establish rotary transmissive coupling between the hub and the power takeoff shaft.

The hub is typically locked onto the shaft by locking members that can slide in radially extending slots through the hub so as to engage a circumferential groove or raceway in the splined power takeoff shaft. A collar around the outside of the hub is biased into a locked position by a spring to prevent the locking members from disengaging or backing away from the shaft.

The coupler disclosed in U.S. Pat. No. 4,900,181 has a stop formed in the collar that extends radially inwardly to abut a stop in the hub when the collar is tilted or cocked with respect to the axis of the shaft. When the shaft is inserted into the hub, locking members in the hub are moved radially outwardly to center the collar and disengage the stops. The collar can then be moved to lock the hub onto the shaft under the bias of a spring. However, the collar can be locked in a disengaged position even though the shaft is fully inserted into the hub. Thus, the hub may appear properly locked onto the shaft despite the collar being disengaged.

U.S. Pat. No. 4,960,344 discloses a coupler in which an eccentrically biased control ring and a concentric locking ring inside the collar operate locking members so that the collar remains concentric with the hub throughout its range of movement. When the shaft is inserted into the hub the locking members drive the control ring outwardly, concentric with the axis to disengage from a stop surface and allow the collar to slide and lock the hub onto the shaft. In this position, the locking ring retains the locking members in engagement with the shaft. However, as with the coupler of U.S. Pat. No. 4,900,181, the locking collar can be moved and locked in the disengaged position even though the shaft is seated in the hub.

A need may exist for a coupler assembly that can provide clear indicia of whether the locking collar is locked in an engaged position with the shaft seated in the hub.

In one independent aspect, an engagement assembly between a drive shaft and a driven shaft for a vehicle may be provided. The engagement assembly may generally include a drive shaft including a plurality of first splines extending in an axial direction and having respective tapered ends tapering in an axial direction; and a driven shaft including a plurality of second splines extending in an axial direction and having respective tapered ends tapering in an axial direction. The first splines and the second splines may be adapted to inter-engage and form a driving connection, the tapered ends facilitating engagement and alignment of the first splines and the second splines.

In another independent aspect, a power take-off coupling for a vehicle and a driven implement may be provided. The coupling may generally include a power take-off shaft of the vehicle including a plurality of male splines extending in an axial direction and having respective tapered ends tapering in an axial direction; and a power input shaft of the implement including a plurality of female splines extending in an axial direction and having respective tapered ends tapering in an axial direction. The female splines may be adapted to receive the male splines and form a driving connection, the tapered ends facilitating engagement and alignment of the male splines and the female splines.

In yet another independent aspect, a method of engaging a drive shaft and a driven shaft may be provided. A connector may be coupled to the driven shaft by a universal joint, the connector being adapted to engage the drive shaft, the drive shaft having a first axis and the connector having a second axis. The method may generally include pivoting the connector relative to the driven shaft to orient the second axis in a predetermined orientation with respect to the first axis; holding the connector in position relative to the driven shaft with the second axis in the predetermined orientation relative to the first axis by locking the universal joint; and engaging the connector of the driven shaft with the drive shaft.

In a further independent aspect, an articulated drive shaft assembly adapted to connect to and be driven by a drive shaft may be provided. The drive shaft assembly may generally include a driven shaft having a first axis; a connector having a second axis and adapted to engage the drive shaft; and a universal joint connecting the connector to the driven shaft, the universal joint including a locking assembly to selectively hold the connector in a position relative to the driven shaft with the first axis in a predetermined orientation relative to the second axis during connection with the drive member.

In another independent aspect, a universal joint may generally include a first yoke having opposite arms each having a bore; a second yoke having opposite arms each having a bore; a cross-shaped trunnion body having four ends, each end being received in a bore of the first yoke and the second yoke; a cap received in each bore and at least partially defining a bearing surface of an associated end of the trunnion body; and a detent mechanism coupled to a cap and associated end of the trunnion body, the detent mechanism having an engaged state, in which pivoting movement between the cap and the associated end of the trunnion body prevented, and a disengaged state, in which pivoting movement between the cap and the end of the trunnion body is allowed.

In yet another independent aspect, a coupler assembly may generally include a hub having a bore defining a bore axis and operable to receive along the bore axis a shaft to be locked to the hub, the hub defining a slot communicating with the bore; a collar disposed about the hub and slidable along the hub between a released position to a locked position; a locking member movable in the slot to engage a recess in the shaft when the shaft is inserted into the bore; a first indicia on the hub indicative of a locked condition of the coupler assembly, in which the locking member engages the recess and the collar is in the locked position; and a second indicia on the hub indicative of an unlocked condition of the coupler assembly, in which the collar is in the unlocked position. In the unlocked condition, the collar may cover the first indicia and exposes the second indicia, and, in the locked condition, the collar may cover the second indicia and exposes the first indicia.

In a further independent aspect, a coupler assembly may generally include a hub having a bore defining a bore axis and operable to receive along the bore axis a shaft to be locked to the hub, the hub having an aperture formed therethrough extending in a direction generally perpendicular to the bore axis and extending at least partially through the bore; and a locking pin disposed in the aperture for movement along the direction between a locked position, in which the locking pin selectively extends into the bore and into a recess in the shaft to lock and prevent the removal of the shaft from the bore, and an unlocked position, the locking pin including a head portion extending outwardly from the hub through one end of the aperture, the head portion including indicia of when the locking pin is the locked position.

Independent features and/or independent advantages of the invention may become apparent to those skilled in the art upon review of the detailed description, claims and drawings.

### BRIEF DESCRIPTION OF DRAWINGS

FIG. 1 is an illustration of a prior art drive shaft coupling.

FIG. 2 is an enlarged view of the partial cross-section of the female coupling of FIG. 1.

FIG. 3 is a partial cross-sectional view of the coupling taken generally along line 3-3 of FIG. 2.

FIG. 4 is a perspective view of a shaft, such as a power take-off shaft, embodying independent aspects of the present invention.

FIG. 5 is a side view of the shaft of FIG. 4.

FIG. 6 is an end view of the shaft of FIG. 4.

FIG. 7 is an enlarged side view of the shaft of FIG. 4.

FIG. 8 is a perspective view of a drive shaft having a coupling embodying independent aspects of the present invention.

FIG. 9 is a cross-sectional view of a portion of the drive shaft and coupling shown in

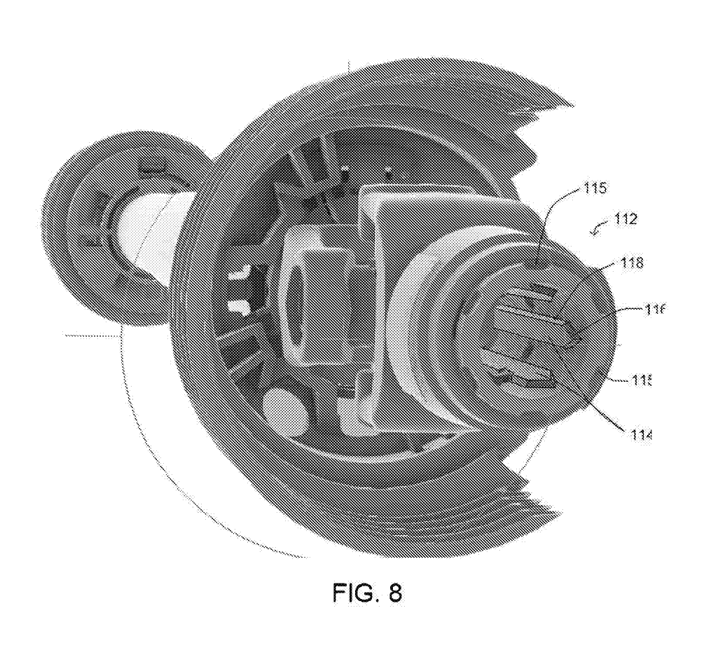

FIG. 8.

FIG. 10 is a perspective view of a power take-off drive shaft prior to engagement with a yoke coupling.

FIG. 11 is a perspective partial cross-sectional view of the drive shaft and the yoke coupling of FIG. 10, illustrating a first alignment condition.

FIG. 12 is a side cross-sectional view of the alignment condition shown in FIG. 11.

FIG. 13 is a perspective partial cross-sectional view of the drive shaft and the yoke coupling of FIG. 10, illustrating a second alignment condition.

FIG. 14 is a side cross-sectional view of the alignment condition shown in FIG. 13.

FIG. 15 is an illustration of a drive shaft coupling between a power take-off shaft and a yoke having a power input connection.

FIG. 16 is an exploded view of a conventional universal joint.

FIG. 17 is perspective view of a drive shaft embodying aspects of the present invention.

FIG. 18 is a perspective view of a drive shaft illustrating a yoke coupled to the universal joint in a pivoted, non-aligned orientation.

FIG. 19 is a perspective view of a universal joint embodying aspects of the present invention.

FIG. 20 is a near end view (partially perspective) of the bearing cap embodying aspects of the present invention.

FIG. 21 is a cross-sectional perspective view of the trunnion body shown in FIG. 19.

FIG. 22 is a partial cross-sectional view of a trunnion end shown in FIG. 21.

FIG. 23 is a partial perspective view of another embodiment of a locking assembly of the present invention.

FIG. 24 is a side view of the bearing cap of FIG. 23 engaged with a modified Belleville Spring.

FIG. 25 is a perspective view of the modified Belleville Spring of FIG. 24.

FIG. 26 is an exploded perspective view of a coupler assembly of the present invention.

FIG. 27 is a partial cross-sectional view of the coupler with the shaft partially inserted into the shaft and the collar in the released position with the elements 28 rotated into the same plane as the elements 38 for illustrative purposes.

FIG. 28 is a view similar to FIG. 27 but with the shaft fully inserted into the hub and the collar in the locked position,

FIG. 29 is an end cross-sectional view showing a latch ring biased eccentrically within the collar about the hub when in the released position of FIG. 27.

FIG. 30 is a view similar to FIG. 28, but without a shaft illustrated.

FIG. 31 is a view similar to FIG. 27, but without the shaft illustrated.

FIG. 32 is a view partially in side elevation and partially in axial section on line 32-32 of FIG. 33 showing a connection between the inner and outer shaft elements.

FIG. 33 is a view taken in cross section on the line 33-33 of FIG. 32.

FIG. 34 is an alternative embodiment of the device shown in FIG. 33.

### DETAILED DESCRIPTION

Before any independent embodiments of the invention are explained in detail, it is to be understood that the invention is not limited in its application to the details of construction and the arrangement of components set forth in the following description or illustrated in the following drawings. The invention is capable of other independent embodiments and of being practiced or of being carried out in various ways. Also, it is to be understood that the phraseology and terminology used herein is for the purpose of description and should not be regarded as limiting.

Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof.

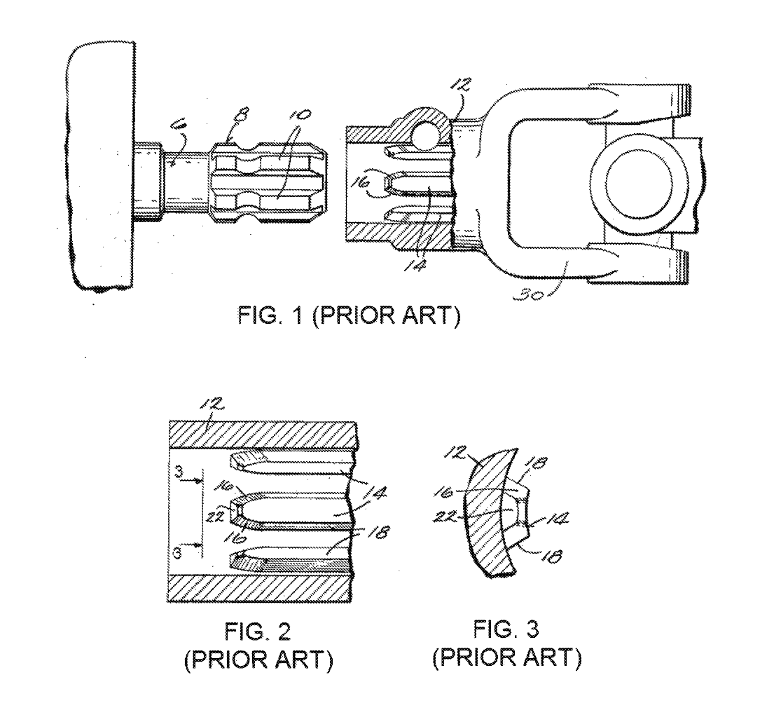

FIGS. 1-3 illustrate a conventional power take-off shaft 6 having a male coupling element 8 at its end provided with splines 10. The female coupling element 12 of the universally jointed and extensible driven shaft is interiorly provided with splines 14 which, throughout the major portion of their length, are complementary to, and mate accurately with, the splines 10 of the driving coupling element 8 of the power take-off shaft 6. As shown in greater detail in FIG. 2, each spline 14 of the female coupling element 12 has radial or involute side surfaces 18 taperingly convergent (at 16) toward the blunt end 22 of the respective spline 14.

As shown in FIGS. 1-3, the ends of both splines 10, 14 have a square or blunt end 22. As such, the splines 10, 14 may still meet “head-on” (i.e., the blunt ends 22 on each set of splines 10, 14 engaging to prevent registration of the splined engagement) in some circumstances.

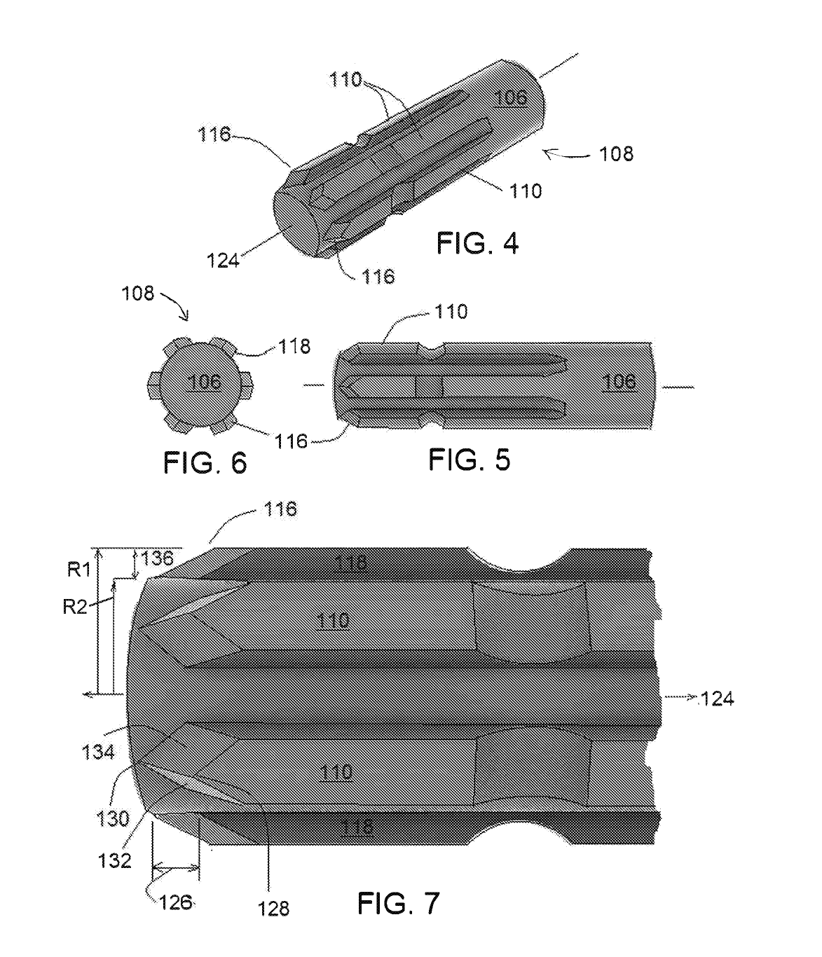

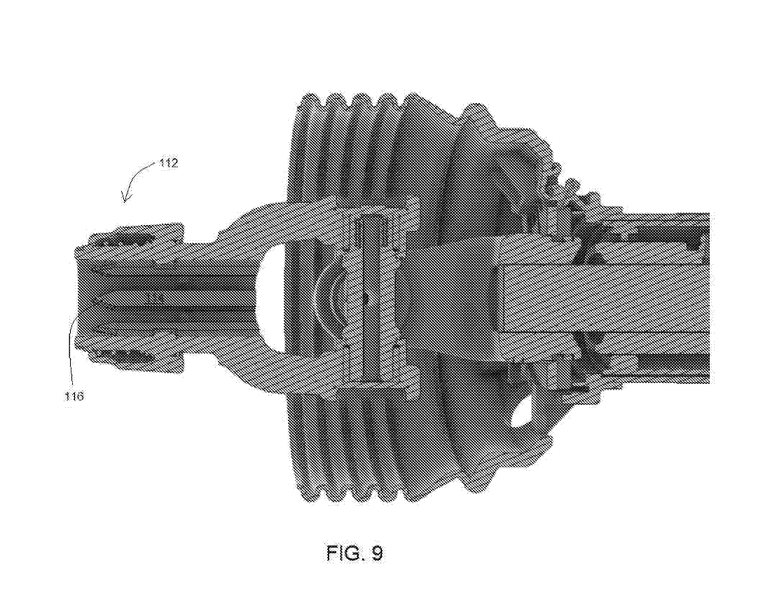

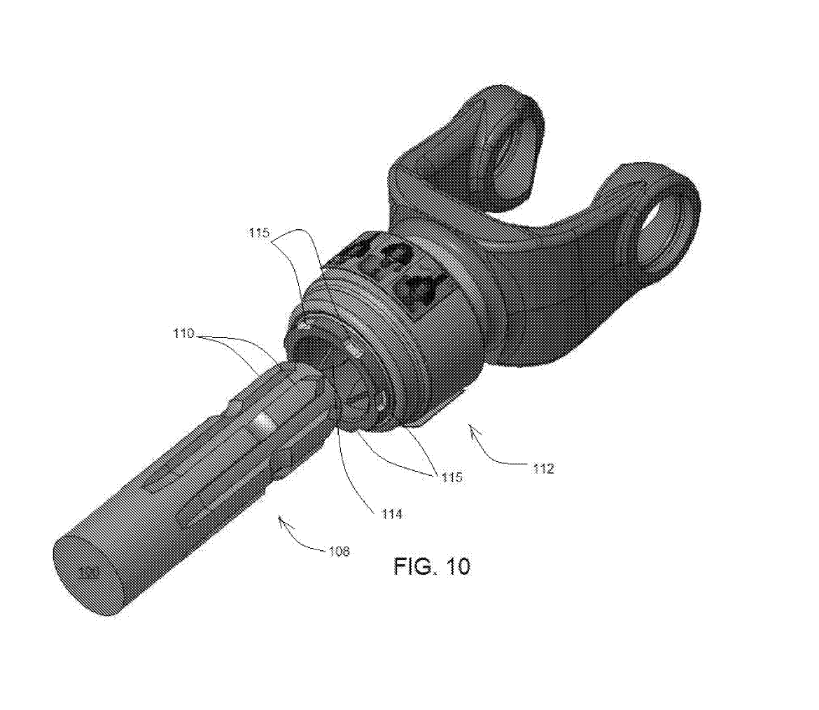

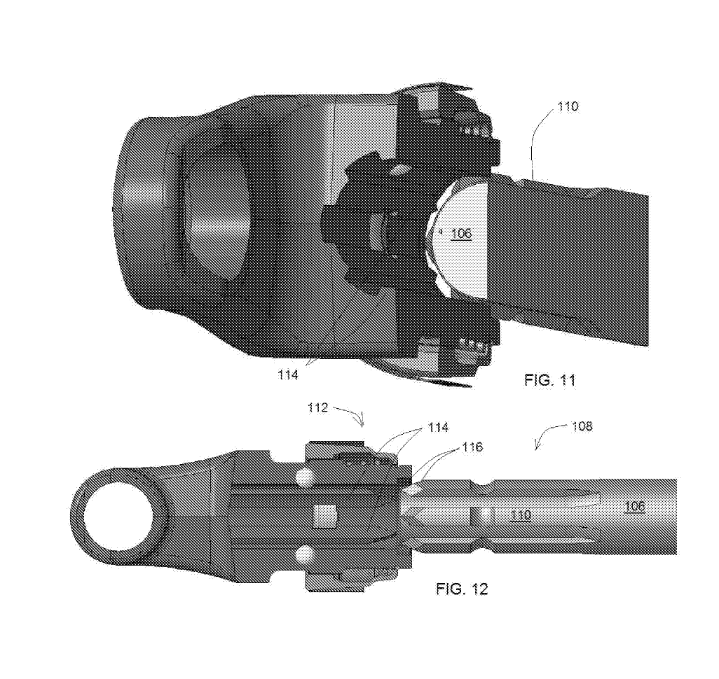

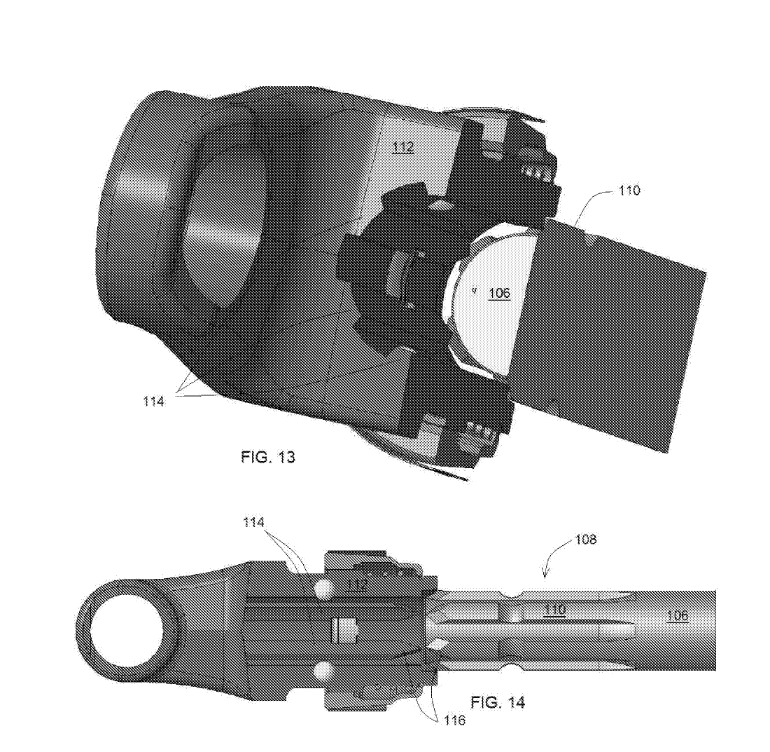

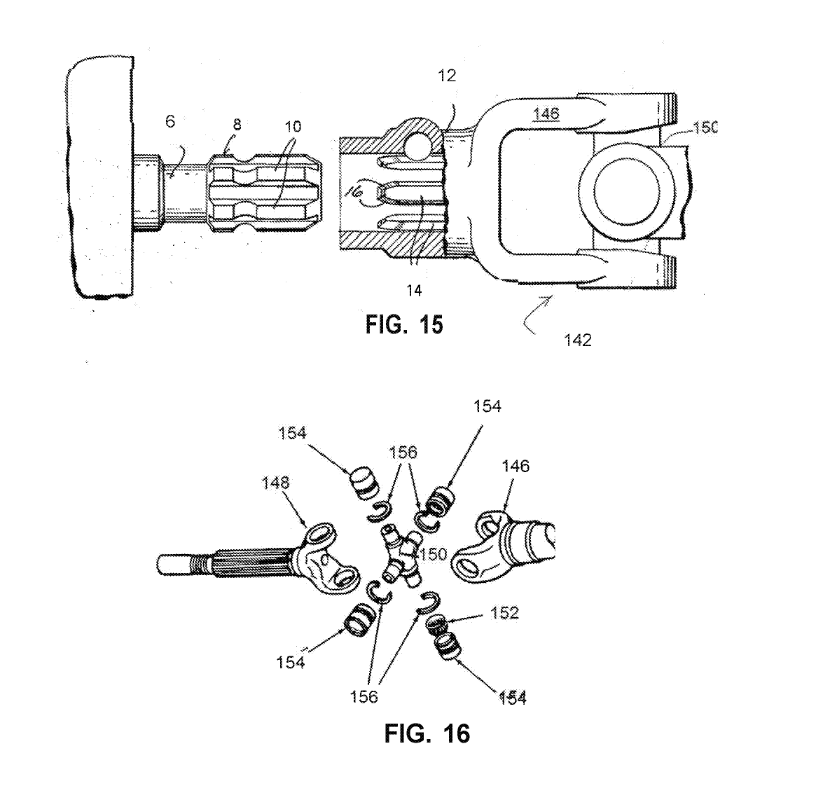

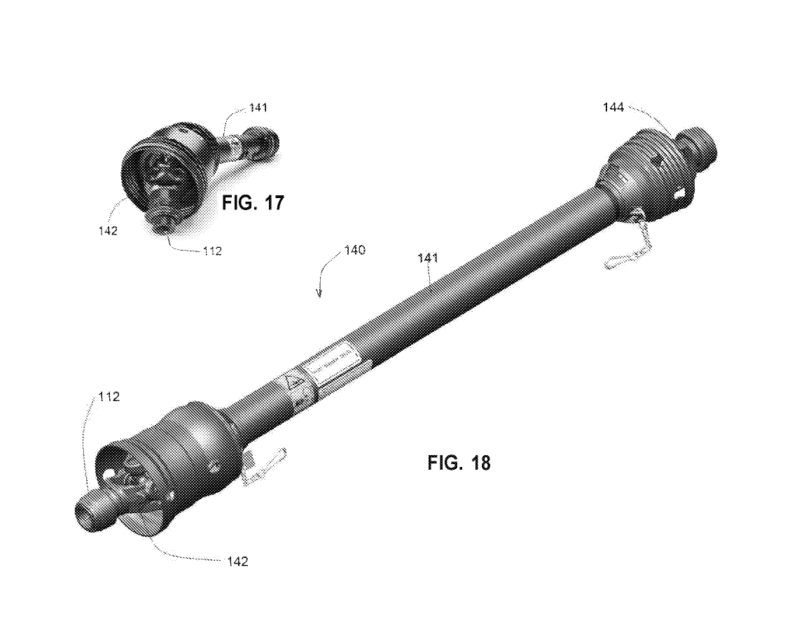

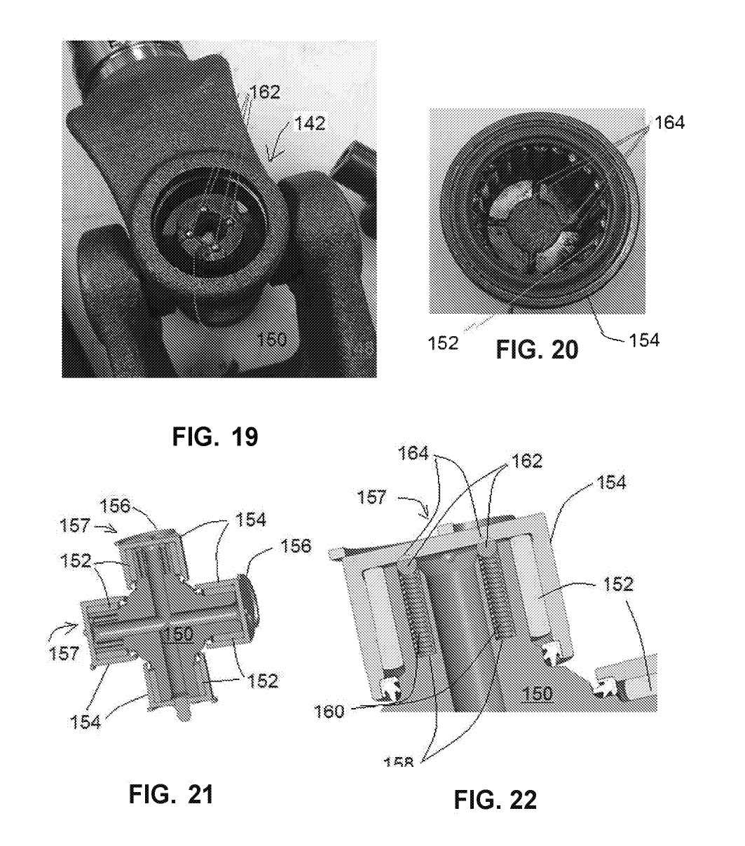

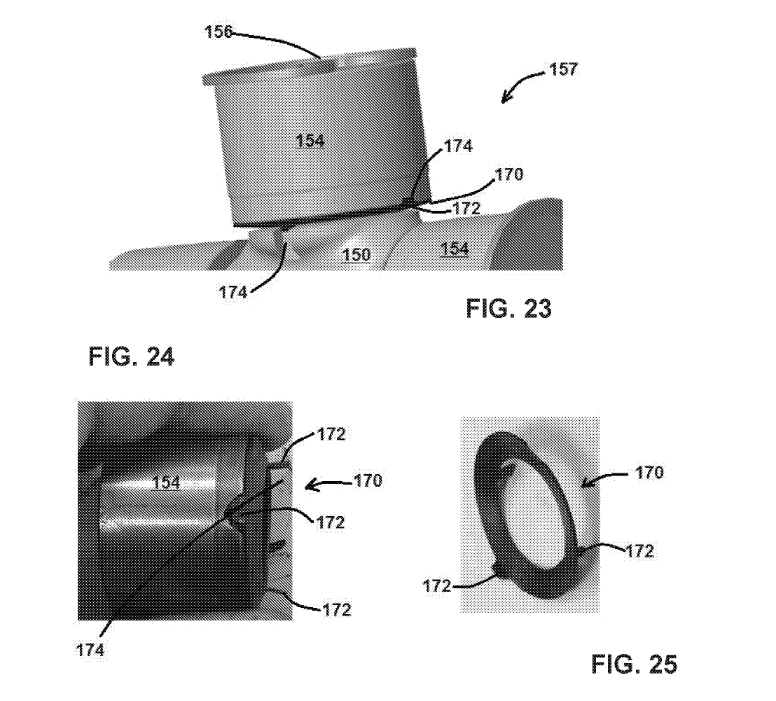

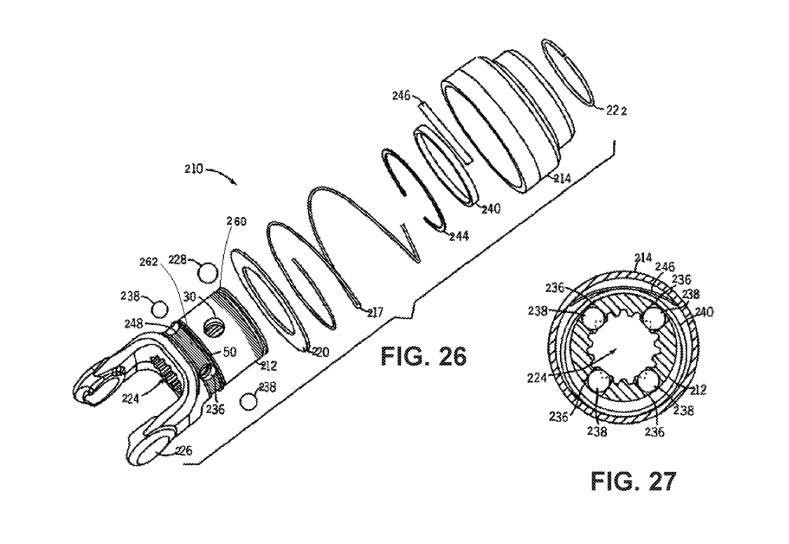

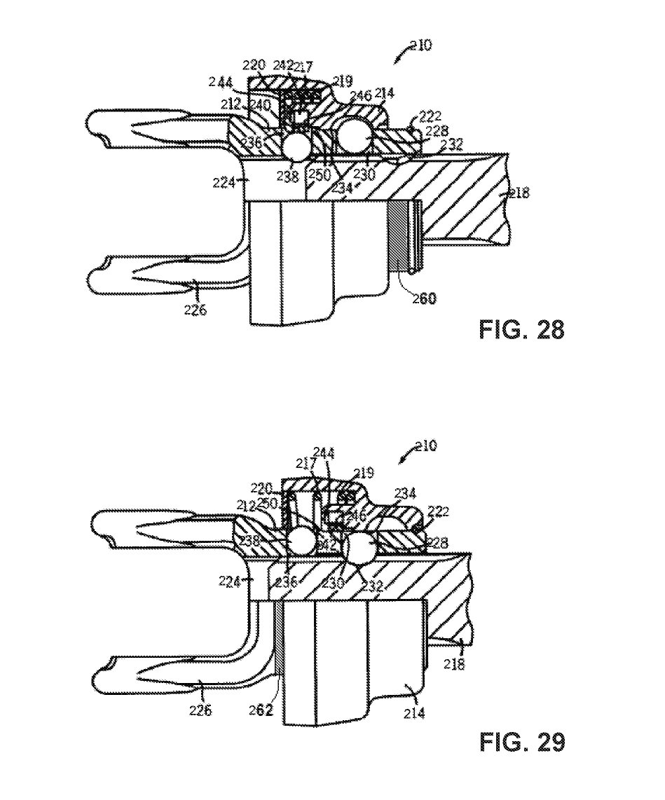

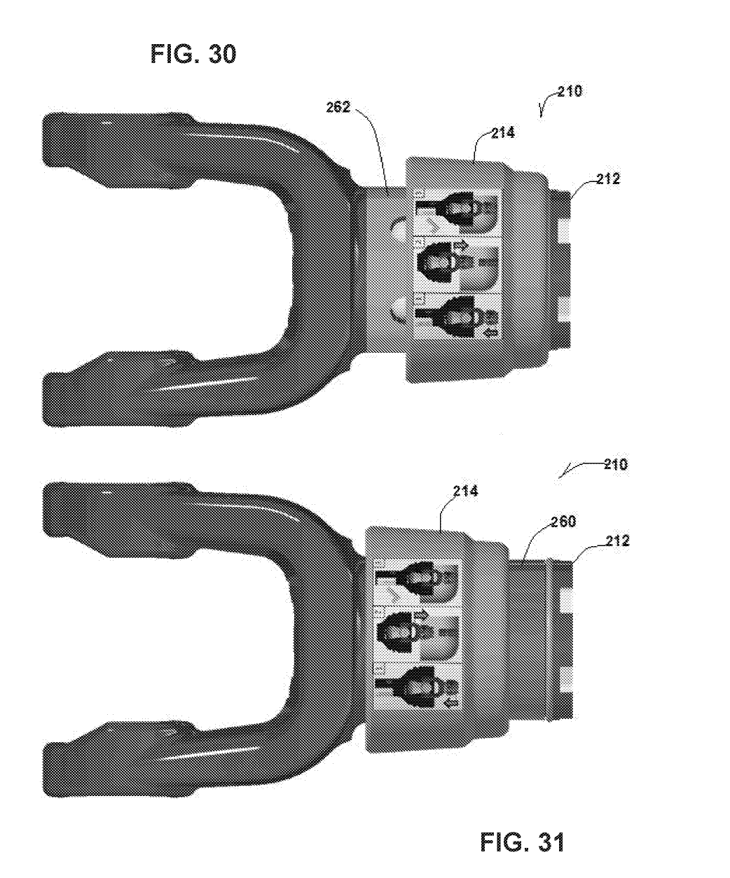

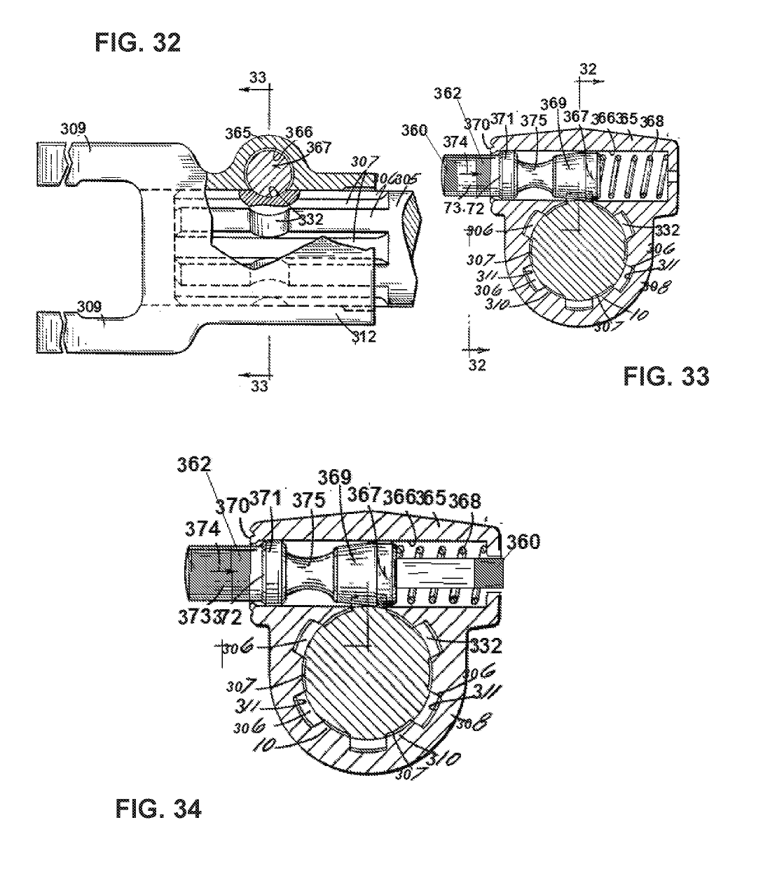

FIGS. 4-7 illustrate a shaft, such as a power take-off drive shaft 106, and FIGS. 8-9 illustrate a connector 112, alone or in combination embodying independent aspects of the present invention. The shaft 106 and/or the connector 112 may, for example, eliminate or reduce the likelihood of head-on engagement of the ends of splines 110, 114, which would prevent engagement of the splined connection. The shaft 106 and/or the connector 112 may be used with tractors, trucks, other off-highway vehicles, etc., and the many implements for such vehicles

As shown in FIGS. 4-7, the shaft 106 has a male coupling element 108 at its end provided with splines 110. Each spline 110 has a side surface extending from the shaft 106. Depending upon the type of shaft, the side surfaces can be straight or involute. Furthermore, more or fewer splines 110 than the six illustrated can be utilized.

As best shown in FIG. 7, each spline 110 has a tapered end 116 terminating at a tip 128, 130 in the axial direction 124. As discussed in greater detail below, a number of different tapers can be utilized. For example, as illustrated both sides 118 of each spline 110 taper in the axial direction 124. However, in some embodiments (not shown), only one side is tapered to form a tip.

With continued reference to FIG. 7, each illustrated spline 110 has both an axial taper 126 and a radial taper 136. With respect to the axial taper 126, the taper 126 begins in the axial direction 124 at a first distance from the end of the spline 110 and terminates at the end of the spline 110. In other words, the width (i.e., circumferentially) of the spline 110 changes with change in the axial direction.

With respect to the radial taper (or chamfer) 136, the taper 136 starts at the outer radius R2 and terminates at the end of the spline 110 at a second radius R1. In the illustrated embodiment, the inner radius is the radius of the shaft 106 at the base of the splines 110. In other words, with a radial taper, the radial height of the spline changes along the length of a spline.

With the illustrated dual taper 126, 136, the end of each spline 110 includes a first point 128 at a first radial distance R1 and a second point 130 at a second radial distance R2. The points 128, 130 are separated along the length of the taper 126, 136 of the spline 110. Surfaces 132 and 134 define the taper 126, 136 between the side surfaces 118 and the points 128, 130.

Although, in the illustrated embodiment, the shaft 106 has a dual taper 126, 136, in other embodiments, the shaft 106 may not have a dual taper. For example, in such embodiments (not shown), a taper may be provided only in the axial direction 124 (i.e., the spline is full height the entire length of the spline).

One way to further define a taper is to discuss angles in which surfaces are positioned relative to reference points, such as an axial direction, a transverse direction, a radial direction, another intersecting surface, etc. Some parameters of the taper of the splines 110 on the shaft 106, which may be preferred in certain embodiments, will now be discussed.

The illustrated axial taper 126 of the splines 110 has a draft angle (e.g., a measure of the angle of surfaces 132 and 134 with respect to the axial direction of the spline 110) of about 34 degrees. As such, without considering the radial taper 136, in the illustrated embodiment, the two surfaces 132, 134 intersect at an angle of about 68 degrees.

Although the illustrated embodiment utilizes a 34 degree draft angle, wider draft angles can be utilized with acceptable results. For example, draft angles of less than about 60 degrees, and, more preferably, less than about 40 degrees can produce acceptable results. Alternatively, the splines 110 may have a pointed edge defined by two surfaces 132 and 134 intersecting at an angle of less than about 80 degrees, or, in other embodiments, less than about 70 degrees.

Other narrower draft angles are also possible; however, when modifying the end on the splines 110 on the shaft 106, applicable regulations and standards may permit only minor modifications. For example, in accordance with current regulations and standards, any modification must generally occur only within about the first one-quarter (¼) inch of the spline 110. Based upon this exemplary limitation, it may difficult to implement narrower draft angles without extending the taper beyond the presently-allowable limits. It should be understood that, if the applicable regulations and standards change in the future (e.g., to allow for a longer modification region), narrower draft angles may be provided and may be preferable for a given application.

As discussed above, the illustrated splines 110 of the shaft 106 also have a radial taper 136. This radial taper 136 is at least partially defined by a chamfer of the splines 110. The illustrated splines 110 have a chamfer angle (e.g., measured as the angle the edge extending from 130 to 132 makes with respect to the axis 124 of the drive shaft 106) of about 29 degrees.

Although the illustrated embodiment utilizes a 29 degree chamfer angle, larger chamfer angles can be utilized with acceptable results. As discussed above, some embodiments do not include a radial taper 136, and, in such an embodiment, the chamfer angle would be 90 degrees. However, when a chamfer is provided, chamfer angles of less than about 60 degrees, or, in some embodiments, less than about 30 degrees can produce acceptable results.

As mentioned above, due to applicable regulations and standards, shallower chamfer angles may not currently be permitted. However, to the extent that regulations allow modifications further along the length of the spline 110, shallower chamfer angles may allow for easier registration of complementary splines 110, 114.

As discussed above, the taper 126, 136 of the spline 110 terminates at a tip 128, 130. This is not meant to mean only a pointed termination. Rather, the taper does not terminate at a surface that can abut head-on with a tapered spline 114 on the connector 112 and prevent engagement of the splines 110, 114. In one example, this means that the spline 110 does not terminate in a large blunted surface (e.g., such as the blunt end 22 in FIGS. 1-3). The term “tip” refers to ends that are pointed, rounded, curvilinear, have a cam-like or other profile that encourage two surfaces to slide past each other upon engagement of the shaft 106 and the connector 112.

FIGS. 8-9 illustrate the connector 112. The connector 112 is coupled to a driven shaft, such as a conventional telescoping driven shaft having a universal joint at each end. Such a connector 112 can be used as part of a power input connection on an implement. As illustrated in FIGS. 10-14, the connector 112 is adapted to work with the shaft 106, discussed above, to prevent or reduce the likelihood of head-on engagement between the splines 110, 114 during attempts to register the drive shaft 106 and driven shaft.

As shown in FIGS. 8-9, the connector 112 includes a female coupling element with internal splines 114. Like the splines 110 on the shaft 106, each spline 114 has a tapered end 116. In the illustrated embodiment, each spline 114 tapers only in the axial direction (e.g., an axial taper). In other words, the illustrated spline 114 changes in width along the axis (beginning at a first distance from the end of the spline 114 and terminating at the end of the spline 114) while retaining its full height along the length. As illustrated, both sides 118 of the spline 114 taper to form an edge defining a tip on the splines 114.

A number of different tapers can be utilized for the splines 114. For example, although both sides 118 of each spline 114 are shown to taper in the axial direction, in some embodiments (not shown), only one side tapers to form a point. Also, like the splines 110 of the shaft 106, the splines 114 of the connector 112 may have a dual taper (i.e., both an axial taper and a radial taper).

Under current regulations and standards, a greater length region of the spline 114 is permitted for modification compared to the drive shaft 106. As such, relatively shallower draft angles (compared to the splines 110 of the shaft 106) are permitted on the internal splines 114 of the coupler 112. These shallower draft angles may provide smooth engagement between the splines 110, 114. In the illustrated embodiment, the internal splines 114 have a draft angle of about 20 degrees.

Other draft angles are possible. Although the illustrated embodiment utilizes a 20 degree draft angle, wider draft angles can be utilized with acceptable results. For example, the draft angle can be less than about 60 degrees, less than about 40 degrees or less than about 20 degrees.

Alternatively, the taper of the female splines 114 can be defined by the angle formed by two surfaces intersecting. In the illustrated embodiment, the two surfaces of the spline 114 intersect at an angle of about 40 degrees. In some embodiments, the two surfaces intersecting at the tip intersect at an angle of less than about 60 degrees, less than about 50 degrees or less than about 40 degrees.

As noted above, the illustrated internal splines 114 do not have a radial taper or, in other words, do not have a chamfer provided. Again, the splines 114 generally retain their full height (or radius) along substantially the entire length of the spline 114. Experiments have shown that a chamfer on the internal splines 114 may not be necessary if and when a chamfer is provided on the external splines 110.

In some cases, with a chamfer is provided on both splines 110, 114, engagement between the splines 110, 114 can be more difficult due to the two tips terminating at points, which may have a tendency to dig into the opposite spline 110 or 114. If properly machined and held to tighter tolerances, chamfered ends on both sets of splines 110, 114 could be utilized without problem. However, for practical purposes (e.g., lower cost manufacturing, reduced risk of damage, tolerance issues, etc.), a chamfer is provided on only one of the sets of splines 110, 114.

As mentioned above, the taper of the spline 114 terminates at a tip. This is not meant to mean only a pointed termination. Rather, the taper does not terminate at a surface that can abut head-on with a tapered spline 110 on the shaft 106 and prevent engagement of the splines 110, 114. In one example, this means that the spline 114 does not terminate in a large blunted surface (e.g., such as the blunt end 22 in FIGS. 1-3). The term “tip” again refers to ends that are pointed, rounded, curvilinear, have a cam-like or other profile that encourage two surfaces to slide

FIGS. 10-14 illustrate the interconnection of the illustrated shaft 106 and the connector 112. FIGS. 11-12 illustrate a first alignment condition of the splines 110, 114, while FIGS. 13-14 illustrate a second alignment condition of the splines 110, 114.

In the first alignment condition (see FIGS. 11-12), the splines 110, 114 are aligned for easy registration. In other words, the projections and grooves of the opposite engaging splines 110, 114 are illustrated in a generally well-aligned condition allowing for easy registration.

FIG. 13-14, on the other hand, attempt to illustrate the tips or points of each spline 110, 114 in as close to a “head-on” configuration as is possible (the second alignment condition). However, even in such an alignment, during insertion of the shaft 106 into the connector 112, the illustrated tips would slide or cam into the adjacent opening between splines 110, 114 to allow for proper registration.

FIGS. 8-10 illustrate an additional independent feature which can aid with alignment and registering engagement of the shaft 106 and the connector 112. As shown, one or more alignment features 115 are provided on an exterior surface of the connector 112. The illustrated alignment features 115 include indicators (e.g., notches, recesses, etc.) aligned with the structure of the internal splines 114 (e.g., in the illustrated embodiment, the recesses between the internal splines 114). However, in other embodiments (not shown), the alignment features 115 can, additionally or alternatively, take other forms (e.g., markings, projections, etc.) aligned with other structure (e.g., the projections of the splines 114).

In operation of the embodiment shown in FIGS. 8-10, an operator will lift and align the connector 112 on the driven shaft with the power take-off shaft 106. Because the operator is not likely to see the location of the internal splines 114 of the connector 112, the operator relies upon the alignment features 115 on the exterior of the connector 112 to indicate the location of, in the illustrated construction, the gaps between the internal splines 114. The operator then aligns the alignment features 115 with the splines 110 of the shaft 106. With these structures being substantially aligned, the splines 110 should properly engage and register with the internal splines 114 as the shaft 106 is inserted and connected to the connector 112.

FIG. 15 again illustrates the conventional power take-off shaft 6, having a male coupling element 8 at its end provided with splines 10, and the female coupling element 12 of the universally-jointed and extensible driven shaft provided with internal splines 14.

FIGS. 17-18 illustrate a universally jointed and extensible driven shaft 140. The shaft assembly 140 includes a shaft 141, which may telescope, with a connector 112 on each end. The shaft assembly 140 also includes a universal joint 142, 144 at each end between the shaft 141 and the connectors 112.

As mentioned above, aligning splines between a power take-off shaft on a tractor and a power input connection on a driven shaft of an implement can be complicated by the size, weight, and complexity of the driven shaft of the implement. The connecting end of the driven shaft typically has a joint, such as a universal joint 142, which can tend to rotate or pivot into a position not aligned with the shaft (see FIG. 19). Thus, the weight combined with the typical misalignment can make connection between the power take-off shaft 106 and the power input connection 112 much more complicated.

As shown in FIG. 16, one particular configuration of a universal joint includes two yokes 146, 148 interconnected via a cross-shaped trunnion body 150 having four trunnion pins around which are positioned bearing elements. These bearing elements are received in bores formed in yoke arms. In particular, the bearing elements include bearings 152 and a bearing cap 154, typically held in place via a snap ring 156.

Within the trunnion 150 are bores which extend through the trunnion pins and intersect in a central cavity which is closed by a suitable lubricant fitting. Sealing rings are provided at the inner ends of each of the bearing caps 154 (see FIGS. 21-22). These sealing rings will permit any excess lubricant supplied during lubrication to escape to the exterior of the universal joint but will prevent any dirt or water from entering into the bearing cavity within the bearing element.

As noted above, due to the construction of a universal joint, the axis of rotation of the two yokes 146, 148 will tend to gravitate toward a non-aligned condition (FIG. 18) with respect to each other and/or the shaft 141 when not connected to a power take-off shaft 106.

In independent aspects, a device for and method of orienting the yokes 146, 148 to assist with aligning the power take-off shaft 106 and the power input connection 112 is provided. In particular, a joint locking assembly 157 is operable to hold each joint 142, 144 in a predetermined orientation. The joint locking assembly 157 can be configured many different ways as long as it holds the joint in the predetermined orientation (e.g., with the connector 112 aligned with the shaft 141).

FIGS. 19-22 illustrate one construction of a joint locking assembly 157. In this embodiment, the universal joint 142 is provided with a modified trunnion body 150. In particular, at least two perpendicularly positioned trunnion ends are provided with a locking assembly 157 to lock the yokes 146, 148 in a specific predefined orientation.

In a conventional universal joint, the trunnion ends freely rotate within the bearing caps 154. This allows the universal joint to gravitate toward the mis-aligned condition shown in FIG. 18. In the illustrated construction, a locking assembly 157 for each trunnion end includes a detent mechanism operable to selectively lock the trunnion 150 against rotation with respect to the bearing cap 154.

The illustrated detent mechanism includes a projecting member 162 biased into engagement with a recess 164 of the bearing cap 154 to prevent rotation of the trunnion end with respect to the bearing cap 154. As illustrated, a spring 160 within a bore 158 of the trunnion end biases a ball 162 into the recess 164 of the bearing cap 154. With the ball 162 engaged with the recess 164, the trunnion end is unable to rotate relative bearing cap 154.

In the illustrated embodiment, four detent mechanisms are provided on a single trunnion end. However, in other embodiments, more or fewer detent mechanisms can be utilized. In some embodiments, as few as one or two detent mechanisms may operate well. In other embodiments, more than four may be used.

As shown in FIGS. 19-21, some embodiments, such as the illustrated embodiment, will incorporate one locking assembly 157 per axis of rotation. Thus, two locking assemblies 157 are illustrated on adjacent trunnion ends to control each axis of rotation of the universal joint 142. However, in other embodiments, each trunnion end can be provided with a locking assembly 157.

In some embodiments, the detent mechanism is specifically configured to hold the joint in a predetermined orientation when not connected to the drive mechanism and allow free movement of the joint when connected to the drive shaft and under a specific torque load. This configuration can be achieved by selecting a spring that will create a force to hold the ball 162 into engagement the recess 164 under the weight and resulting forces of the yokes 146, 148. In other words, the spring 160 pushes the ball 162 into engagement with the recess 164 with greater force than is normally produced on the joint under the weight of the yoke 146 or 148 alone.

When the locking assemblies 157 are engaged (i.e., the detent mechanisms are aligned with the ball 162 engaging the recess 164) and the forces on the joint create a torque less than the threshold amount, the joint is locked against pivotal movement. As such, the connector 112 is oriented in a predetermined orientation for easy engagement between the shaft assembly 140 and the power take-off shaft 106. In the illustrated embodiment, the locking assemblies 157 hold the yokes 146, 148 in an orientation that substantially aligns the axis of rotation of the connector 112 with the axis of rotation of the driven shaft 141. With the connector 112 held in substantial alignment with the shaft 141, connection between the power take-off shaft 106 and the power input coupling 12 can be completed substantially easier than is conventionally done.

As noted above, in some embodiments, the predetermined orientation aligns the axis of the connector 112 and the axis of the shaft 141. However, for other embodiments (not shown), this particular orientation may not be very helpful, for example, if the opposite end 144 of the drive shaft assembly 140 is already connected to an implement and that connection is at a different height than the power take-off shaft 106. Thus, in some embodiments, the predetermined orientation may be an orientation in which the axis of rotation of each coupler 112 is substantially parallel to each other but not parallel with the axis of rotation of the drive shaft 141.

In some constructions the locking assembly 157 may be constructed to hold the joint in more than one predetermined orientation (e.g., with the connector 112 aligned with the shaft 141 or the axis of each coupler 112 parallel to each other but not parallel with the axis of rotation of the drive shaft 141).

During operation, after connection of the implement, the forces on the joint 142 increase quite substantially (i.e., exceeding the threshold), overcoming the force of the spring 160 and causing the ball 162 to retract into the bore 158 against the force of the spring 160. Due to the configuration of the ball 162, the relative torque created between the trunnion 150 and the bearing cap 154 causes the bearing cap 154 to cam the recess 164 to disengage the ball 162 and force the ball 162 against the spring 160 into the bore 158.

When operation is complete and the driven shaft is disconnected, the detent mechanism can re-engage and hold the universal joint in the predetermined orientation for disconnection of and/or future connection of the shaft assembly 140 with a drive shaft 106 of a tractor. In other words, the balls 162 can be biased into engagement with recesses 164 upon disconnection to hold the joint in a desired orientation. During disconnection of the driven shaft 140 and the drive shaft 106, the connector 112 may not be properly oriented to allow the detent mechanism to engage. As such, upon disconnection, the operator may have to manipulate the connector end and move it toward an aligned condition reengage the locking assembly 157 and hold the connector end and shaft 141 in a generally aligned orientation.

Although the illustrated embodiment utilizes a ball 162 as part of the detent mechanism, in other embodiments (not shown), other projecting structures can be utilized. For example, a pin with a generally rounded end can function much like the illustrated ball 162, with the rounded end helping to create the camming effect that forces the detent mechanism into disengagement as discussed above.

In some embodiments, non-rounded pins and generally cylindrical recesses may also be used to prevent relative movement between the trunnion end and the bearing cap during engagement of the drive shaft. In such an embodiment, disengagement can be created by shearing the pin once sufficient torque is applied to the joint during use. Unfortunately, with such an embodiment, the locking assembly would not be reusable.

FIGS. 23-25 illustrate another embodiment of a locking assembly 157. In this embodiment, a modified Belleville Spring 170 biases the trunnion 150 and bearing cap 154 into a locked orientation (see FIG. 23). Belleville Springs, Belleville Washers or disk springs are conical shaped circular springs. The springs 170 are designed to be loaded in the direction perpendicular to the washer, i.e., by compressing the cone, and they may be loaded statically or dynamically.

As best illustrated in FIG. 25, the modified Belleville Spring 170 includes projecting members or detents 172. As shown in FIGS. 23-24, these detents 172 can align with and engage corresponding recesses 174 on the trunnion body 150 and bearing cap 154. When aligned as illustrated, the joint is prevented from rotating. When sufficient torque is applied to the joint, the detents 172 react against the recesses 174 and cause the Belleville Spring to flex into an orientation in which the detents 172 release from the recesses 174 on at least one of the bearing cap 154 or the trunnion body 150.

In operation, the modified Belleville Spring 170 will lock the bearing cap 154 into a fixed orientation with respect to the trunnion body 150 via the engagement of the detents 172 on the top and bottom of the Belleville Spring 170 with the recesses 174 in the bearing cap 154 and the trunnion body 150. When torque applied to the joint is below a predefined threshold, the Belleville Spring 170 will maintain its shape and hold the joint in a locked orientation. However, above the predefined threshold torque, the Belleville Spring 170 will flex, allowing the detents 172 to disengage from the recesses 174 of either the bearing cap 154 or the trunnion body 150. In the configuration shown, the detents 172 will disengage from the recesses 174 of the bearing cap 154. As shown in FIG. 24, the recesses 174 can be curved or rounded to provide a camming action between the recesses 174 and the detents 172 to drive the Belleville Spring 170 toward a flexed condition.

Once the torque on the joint drops below the threshold torque, the Belleville Spring 170 will return to its original condition. This will allow the detents 172 to reengage the recesses 174 and once again lock the joint against rotation.

In other constructions (not shown), a torsional spring having an end that disengages with either the trunnion body or the bearing cap can be used in place of the Belleville Spring. Alternatively, a detent can extend from the trunnion radially (opposed to axially as shown in FIGS. 19-22) and engage recesses within a side wall of the bearing cap.

In other embodiments (not shown), separate external structures are added to the universal joint 142 to hold the yokes 146 and 148 in the predetermined orientation with respect to each other and to the shaft 141. For example, structures (e.g., shims, wedges, blocks, etc.) can be placed in the gaps between the trunnion body 150 and the yokes 146, 148 to hold them in a predetermined orientation while the structures are engaged with the yoke.

In still other embodiments (not shown), a rigid structural member such as a bar, rod, or shaft can be connected between the shaft 141 and connector 112 to maintain a predetermined alignment. In particular, such a rigid structural member can be temporarily coupled to the connector 112 and the shaft 141 during alignment and engagement of the driven shaft with the drive shaft.

The rigid structural member can be coupled to the shaft 141 and connector 112 many different ways. For example, such a member can held in place (e.g., strapped to each item) with a band or a strap. In some embodiments (not shown), connecting members can be permanently added to the shaft 141 and connector 112 for receiving the rigid structural member. Such connecting members can include apertures for receiving a portion of the rigid structure member or more complex fastening devices such as latches, fasteners, catches, clasps, etc.

FIGS. 26-28 illustrated a coupling assembly 210 including locking indicia. It should be understood that, in other constructions, various other coupling assemblies can incorporate the locking indicia described.

As shown in FIGS. 26-28, the coupling assembly 210 includes, as main components, a hub 212, a collar 214 and a latch assembly. Generally, the latch assembly locks or latches the collar 214 in a released position shown in FIG. 27 until an axially-extending splined shaft 218 is inserted in the hub 212, after which the collar 214 slides along the hub 12 to a locked position shown in FIG. 3.

As best seen in FIGS. 26-28, lock indicating indicia 260, 262 is provided on two locations on the hub 212. The first indicia 260 is located adjacent the distal end of the hub 212 and the second indicia 262 is adjacent the yoke coupled to the hub 212. The first indicia 260 is intended to indicate an unlocked condition, while the second indicia 262 is intended to indicate a locked condition.

The position of the collar 214 determines which indicia 260 or 262 is showing and the condition the coupling assembly 210 (i.e., locked or unlocked). In FIG. 27, the collar 214 is in the unlocked condition, and, in this condition, the first indicia 260 is showing while the second indicia 262 is covered by the collar 214. In FIG. 28, the collar 214 is in the locked condition, and in this condition, the second indicia 262 is showing while the first indicia 260 is covered by the collar 214.

In some embodiments, the indicia 260, 262 include colored sections, in which the first (unlocked) indicia 260 is red and the second (locked) indicia 262 is green. In other embodiments, the indicia 260, 262 include colors, words, symbols, or combinations thereof

Below, one particular embodiment of a coupling assembly 210 will be described. It should be understood that other known coupling assemblies can be used with the indicia 260, 262 of the present invention.

As shown in FIGS. 26-28, the collar 214 is biased toward the locked position by a compression spring 217 of the latch assembly disposed about the hub 212 and acting between a washer or stop ring 220 and an inner annular pocket 219 in the collar 214. The stop ring 220 is affixed to the hub 212 by bias of the spring 17 although it could be formed integrally or connected (e.g., welded) thereto. A snap ring 222 fits in a circumferential groove at the front of the hub 212 to prevent the collar 214 from being pushed off the hub 212 by the spring 217.

As discussed above, the bore 224 of the hub 212 is internally splined to mate with external splines of the shaft 218. The rear end of the hub 212 forms a yoke 226 for attaching the hub 212 to a device to be driven by the shaft 218. For example, the shaft 218 could be part of a power takeoff of a tractor and used to drive an agricultural implement.

The hub 212 and the shaft 218 are locked together by two locking members 228 disposed in corresponding radial slots 230 in the hub 212 angularly spaced apart by 180 degrees. The slots 230 open at the outer and inner diameters of the hub 212 and taper inwardly to have a reduced diameter at the inner diameter so that the locking members 228 may protrude into the bore 224 without passing completely through the slots 230. There is sufficient clearance between the slots 230 and the locking members 228 to allow them to move radially in the slots 230.

The locking members 228 preferably are balls that can roll and slide within the slots 230 so that, when the shaft 218 is inserted in the bore 224 of the hub 212, the locking members 228 engage a circumferential groove or recess 232 about the periphery of the shaft 218 spaced in from the end. When the collar 214 is moved to the locked position, an annular cam surface 234 at the inner diameter of the collar 214 will contact and move the locking members 228 inwardly into the recess 232. The collar 214 maintains the locking members 228 in this inward position so that the shaft 218 cannot be moved axially inward or outward and disengage from the hub 212.

Referring now to FIGS. 27 and 29, the hub 212 also includes a set of four radial slots 236 spaced apart approximately 90 degrees around the circumference of the hub 212 and axially behind the locking member slots 230. The slots 230 open at the outer and inner diameters of the hub 212 and taper inwardly to have a reduced diameter at the inner diameter so that ball-shaped release members 238 contained therein can protrude, but not pass into the bore 224 of the hub 212. There is sufficient clearance between the slots 236 and the release members 238 when the collar 214 is in the released position such that the release members 238 can roll and slide radially therein.

A latch ring 240 is disposed about the release members 238 and contained in an annular channel 242 inside the collar 214 by a retaining ring 244 having a smaller inner diameter than the outer diameter of the latch ring 240. A leaf spring 246 in the channel 242 biases the latch ring 240 eccentrically with respect to the hub 212.

Referring to FIGS. 26-27 and 29, in the released position, opposite arcs of the latch ring 240 rest against the recessed outer diameter 248 of the hub 212 and the inner diameter of the collar 214 under the force of the leaf spring 246. In this position, the latch ring 240 engages an annular ledge 250 extending radially outwardly around the outer diameter of the hub 212 on one side of the latch ring 240 and the inner radially-extending side face of the retaining ring 244 on the other side of the latch ring 240. The collar 214 is thus prevented from being slid along the hub 212 by the spring 217 due to the contact of the latch ring 240 with the hub ledge 250 and the inner surfaces, particularly, the side face of the ring 244 and of the collar 214 defining the channel 242.

The ledge 250 is sized so that the diameter of the release members 238 are at least equal to the distance from the inner diameter of the bore 224 to the radial outer edge of the ledge 250. Thus, when the shaft 218 is inserted into the bore 224, the raised spline surface of the shaft 218 cams the release members 238 radially outwardly. The release members 238 thereby push the latch ring 240 radially outwardly beyond the ledge 250 and concentric with the hub 212. This movement releases the latch ring 240 from the ledge 250 of the hub 212 and allows the spring 217 to move the collar toward the locked position (right in FIGS. 27-28).

As mentioned above, the annular cam surface 234 at the inner diameter of the collar 214 will contact and move the locking members 228 inwardly into the peripheral shaft recess 232. The collar 214 maintains the locking members 228 in this inward position so that the shaft 218 cannot be moved axially to disengage from the hub 212.

Thus, the collar 214 is initially latched in the released position (i.e., before the shaft 218 is inserted in the hub 212) with the unlocked indicia 260 showing. Upon insertion of the shaft 218 into the bore 224, the locking members 228 are cammed radially outwardly in the slots 230, as shown in FIG. 27. As the shaft 218 is inserted further, the release members 238 are cammed radially outwardly by the shaft 218 against the leaf spring 246 to disengage the latch ring 240 from the ledge 250 of the hub 212, thereby allowing the spring 217 to move the collar 214 from the released position to the locked position shown in FIG. 28, which covers the unlocked indicia 260 and uncovers the locked indicia 262. In doing so, the cam surface 234 of the collar 214 cams the locking members 228 radially inwardly into the groove or recess 232 of the shaft 218 to axially lock the hub 212 onto the shaft 218.

As long as the shaft 218 is fully in the bore 224, the release members 238 remain in the radially outward position to lockout the latch ring 240 so it cannot re-engage the ledge 250 in the event the collar 214 was moved back against the spring 217. Thus, the collar 214 is prevented from latching in the released position when the shaft 218 is engaged with the hub 212.

The shaft 218 can be disengaged from the hub 212 only by manually pulling the collar 214 backward (to the left in FIG. 28) against the spring 217. As mentioned above, the collar 214 will not latch in this position until the shaft 218 is pulled out of the bore 214. Once the shaft 218 is removed, the latch ring 240 can re-engage with the ledge 250 and the collar 214 can be latched in the released position, concentric with the hub 212, again with the unlocked indicia 260 showing.

As shown in FIGS. 30-31, in some embodiments, usage instructions are directly coupled to the coupler assembly 210. As illustrated, the instructions are included on the collar 214. The instructions can be a label or sticker coupled to the coupler assembly 210. Alternatively, the instructions can be directly applied to the coupler assembly 210 via paint, engraving, etching, etc.

The instructions in FIGS. 30-31 illustrate three steps. In the first step, the collar 214 is moved from the position shown in FIG. 30 to the position shown in FIG. 31 to place the collar 214 in the unlocked condition, which exposes the red (unlocked) indicia 260. In the second step, the coupler assembly 210 is illustrated as being placed in engagement with a shaft while the collar remains in the unlocked condition of FIG. 31. Finally, in the third step, the instructions show the collar 214 in the locked condition (of FIG. 30) when the coupler assembly 210 is properly engaged with the shaft. In this step, the green (locked) indicia 62 is visible, indicating that the coupler assembly 210 is in the locked condition, which will prevent release of the shaft until the collar 214 is manually moved to the unlocked position (shown in FIG. 31).

As mentioned above, the visual indicia 260, 262 can be used with other shaft locking mechanisms, such as with a push pin style connector shown and described in U.S. Pat. Nos. 3,240,519 and 4,645,368, the entire contents of which are hereby incorporated by reference with respect to its teachings of the connector. FIGS. 32-34 briefly illustrate how this concept would work.

In FIG. 32, the inner element is a shaft 305 having axial splines 306 defined by slots 307 opening to the end of the shaft 305. The outer shaft element comprises the yoke hub 308 which, merely by way of exemplification, has integral arms 309. Interiorly, the hub 308 has splines 310 complementary to the channels 307 of the inner shaft element 305 and it has spaces 311 complementary to the splines 306 of the inner shaft 306.

The segments 332 of a peripheral channel have been cut in splines 306 of the inner shaft 306. The outer shaft element 308 has a boss 315 provided with a transverse bore 366 tangential to at least one of the channel segments 332. The locking pin 367, reciprocable in the bore 366, is biased by a compression spring 368 to a position in which the tapered portion 369 of the locking pin 367 wedge in engagement with that channel segment 332 which is intersected by the bore 366. With the locking pin 367 positioned as shown in FIG. 33, the shaft elements 305 and 308 are securely coupled against axial separation (for rotational purposes, they are, of course, coupled by the splines 306, 310).

The spring 368 may bear directly against the end of bore 366. At its other end, the bore 366 is swedged or staked to reduce its diameter at 370 to provide a stop abutted by the annular locking pin flange 371, which fits the bore. The flange 371 has a shoulder 372 beyond which projects a reduced radius 373 of the locking pin 367, this serving as a push button for displacing the locking pin 367 against the bias of spring 378. When the locking pin 367 is thus displaced by pushing the projecting button 373 in the direction of arrow 374, the reduced neck 375 of the locking pin 367 will register with the spline 306 with which the locking pin 367 was originally engaged. Because the neck 375 is sufficiently small so that the spline 306 will not be obstructed thereby, when the locking pin portion 67 is thus displaced against the pressure of its spring, the inner and outer shaft elements may readily be separated axially, or readily re-engaged. Nevertheless, with the locking pin 367 in the position shown in FIG. 34, the inner and outer shaft elements will be securely locked against axial separation.

As shown on FIG. 33, the visual indicia 260, 262 can be provided on the end of the locking pin 367. Due to the construction of this device, only the unlocked indicia 260 will show in the unlocked condition (not shown) with the locking pin 367 pushed into the bore 366. However, as shown in FIG. 34, the locked indicia 262 becomes visible when the locking pin 367 is moved to the locked position.

FIG. 34 illustrates an alternative embodiment of the locking pin 367 and bore of the embodiment shown in FIG. 33. As shown in FIG. 34, the bore 366 is a through bore and the pin 367 can extend out either end of the bore 366 depending upon the locking condition of the coupler. As illustrated in FIG. 34, the coupler is in the locked position with the locked condition visual indicator 262 visible on the exposed end of the locking pin 367. As shown, the unlocked condition visual indicator 260 is contained within the bore 366. When the locking pin 367 is pushed in the opposite direction of that shown, the locking pin 367 would be moved to an unlocked position in which the unlocked condition visual indictor 260 is exposed through the right end of the bore 366 while the locking position visual indicator 262 would be contained within the bore 366.

It should be understood that the instructions provided in FIGS. 30-31 can also be provided on the embodiments of FIGS. 32-34.

Although the invention has be described in detail with reference to certain preferred independent embodiments, variations and modifications exist within the scope and spirit of one or more independent aspects of the invention as described above. It should be understood that independent features disclosed in the application (e.g., splined connection, joint locking assembly, the locking indicia, etc.) may be employed alone or in combination with one or more additional disclosed features.

It should also be understood that, while the detailed description was provided with reference to a tractor and an implement, in other embodiments, independent features of the invention can be used between a vehicle and another accessory or within a single vehicle. For example, the disclosed splined connection, joint locking assembly, and/or the locking indicia can be used between a vehicle and another accessory or within a single vehicle to connect one shaft to another.

One or more independent features and independent advantages of the invention may be set forth in the claims.

1-15. (canceled)

16. The drive shaft assembly of claim 36, wherein the assembly includes a power take-off coupling for a vehicle and a driven implement, the coupling comprising:
a power take-off shaft of the vehicle including a plurality of male splines extending in an axial direction and having respective tapered ends tapering in an axial direction; and
a power input shaft of the implement including a plurality of female splines extending in an axial direction and having respective tapered ends tapering in an axial direction;
wherein the female splines are adapted to receive the male splines and form a driving connection, the tapered ends facilitating engagement and alignment of the male splines and the female splines.

17-28. (canceled)

29. A method of engaging a drive shaft and a driven shaft, a connector being coupled to the driven shaft by a universal joint, the connector being adapted to engage the drive shaft, the drive shaft having a first axis and the connector having a second axis, the method comprising:
pivoting the connector relative to the driven shaft to orient the second axis in a predetermined orientation with respect to the first axis;
holding the connector in position relative to the driven shaft with the second axis in the predetermined orientation relative to the first axis by locking the universal joint; and
engaging the connector of the driven shaft with the drive shaft.

30. The method of claim 29, wherein locking the universal joint includes engaging a detent mechanism to selectively prevent pivoting movement of the connector relative to the driven shaft.

31. The method of claim 30, wherein the universal joint includes a yoke and a trunnion, and wherein engaging a detent mechanism includes biasing a projecting member into engagement with a recess between the yoke and the trunnion.

32. The method of claim 29, wherein locking the universal joint includes selectively preventing pivoting movement of the connector relative to the driven shaft below a threshold torque.

33. The method of claim 32, further comprising, after engaging the connector, applying torque to the universal joint above the threshold torque to unlock the universal joint and allow pivoting movement of the connector relative to the driven shaft.

34-35. (canceled)

36. An articulated drive shaft assembly adapted to connect to and be driven by a drive shaft, the drive shaft assembly comprising:
a driven shaft having a first axis;
a connector having a second axis and adapted to engage the drive shaft; and
a universal joint connecting the connector to the driven shaft, the universal joint including a locking assembly to selectively hold the connector in a position relative to the driven shaft with the first axis in a predetermined orientation relative to the second axis during connection with the drive member.

37. The drive shaft assembly of claim 36, wherein the locking assembly includes a detent mechanism engageable to selectively prevent pivoting movement of the connector relative to the driven shaft.

38. The drive shaft assembly of claim 37, wherein the universal joint includes a yoke and a trunnion, and wherein the detent mechanism includes, between the yoke and the trunnion, a projecting member engageable with a recess.

39. The drive shaft assembly of claim 38, wherein the projecting member is coupled to an end of a trunnion and the recess is defined by a bearing cap of the universal joint, and wherein the detent mechanism includes a biasing member operable to bias the projecting member into engagement with the recess, the detent mechanism having an engaged configuration below a threshold torque, in which pivoting movement of the connector relative to the driven shaft is prevented, and a disengaged configuration above the threshold torque, in which pivoting movement of the connector relative to the driven shaft is allowed.

40-41. (canceled)

42. The drive shaft assembly of claim 36, wherein the locking assembly is configured to selectively prevent pivoting movement of the connector relative to the driven shaft below a threshold torque, and wherein the locking assembly is configured to be unlocked above the threshold torque to unlock the universal joint and allow pivoting movement of the connector relative to the driven shaft.

43. (canceled)

44. The drive shaft assembly of claim 36, wherein the connector includes a power input connection adapted to matingly engage a power take-off drive shaft.

45. (canceled)

46. The drive shaft assembly of claim 36, further comprising a coupler assembly adjustable between a locked condition, in which the drive shaft is locked to the connector, and an unlocked condition, the coupler assembly including
a locking member movable to engage a recess in the drive shaft in the locked condition,
a first indicia indicative of a locked condition of the coupler assembly, and
a second indicia indicative of an unlocked condition of the coupler assembly
wherein the drive shaft includes a power take-off connection on a vehicle and the driven shaft includes a power input connection for an implement.

47. (canceled)

48. The drive shaft assembly of claim 36, wherein the universal joint includes
a first yoke having opposite arms each having a bore;
a second yoke having opposite arms each having a bore;
a cross-shaped trunnion body having four ends, each end being received in a bore of the first yoke and the second yoke; and
a cap received in each bore and at least partially defining a bearing surface of an associated end of the trunnion body;
wherein the locking assembly includes a detent mechanism coupled to a cap and associated end of the trunnion body, the detent mechanism having an engaged state, in which pivoting movement between the cap and the associated end of the trunnion body prevented, and a disengaged state, in which pivoting movement between the cap and the end of the trunnion body is allowed,
wherein the detent mechanism includes, between the cap and the associated end of the trunnion body, a projecting member and a recess, in the engaged state, the projecting member engaging the recess, and
wherein the locking assembly includes a second detent mechanism coupled to a second cap and an associated second end of the trunnion body.

49. (canceled)

50. The drive shaft assembly of claim 48, wherein the projecting member is supported on the associated end of the trunnion body and the recess is defined in the cap, the projecting member is biased into engagement with the recess.

51-52. (canceled)

53. A coupler assembly comprising:
a hub having a bore defining a bore axis and operable to receive along the bore axis a shaft to be locked to the hub, the hub defining a slot communicating with the bore;
a locking member movable in the slot to engage a recess in the shaft when the shaft is inserted into the bore;
a first indicia indicative of a locked condition of the coupler assembly, in which the locking member engages the recess; and
a second indicia indicative of an unlocked condition of the coupler assembly.

54. The coupler assembly of claim 53, further comprising:
a collar disposed about the hub and slidable along the hub between a released position and a locked position;
a collar latch assembly operable to selectively hold the collar in the released position; and
instructions on the collar illustrating a meaning of the indicia; and
wherein the indicia include a color, a symbol, a word or combinations thereof.

55. The coupler assembly of claim 54, wherein the hub defines a second slot spaced from the first-mentioned slot, wherein the collar defines a channel at its inner diameter, and wherein the collar latch assembly includes
a release member movable in the second slot communicating with the bore, and
a latch ring eccentrically disposed about the hub and the release member when the collar is in the released position with one side of the latch ring engaging a ledge of the hub and an opposite side of the latch ring engaging a surface of the collar to hold the collar in the released position, the collar being held in the released position until the shaft is inserted into the hub bore to move the release member and the latch ring outwardly to release the latch ring from engagement with the ledge and permit movement of the collar to the locked position, the release member preventing the latch ring from engaging the ledge in a fully inserted position of the shaft.

56-59. (canceled)

60. The coupler assembly of claim 53, wherein the hub has an aperture formed therethrough extending in a direction generally perpendicular to the bore axis and extending at least partially through the bore; and
wherein the locking member includes a locking pin disposed in the aperture for movement along the direction between a locked position, in which the locking pin selectively extends into the bore and into a recess in the shaft to lock and prevent the removal of the shaft from the bore, and an unlocked position, the locking pin including a head portion extending outwardly from the hub through one end of the aperture, the head portion including the first indicia.

61. The coupler assembly of claim 60, wherein the head portion also includes
the second indicia,
wherein, in the unlocked position, the first indicia is covered by the hub and the second indicia is exposed, and wherein, in the locked condition, the first indicia is exposed.

62-63. (canceled)
